(19) United States
(12) Patent Application Publication
(10) Pub. No.: US 2014/0196129 A1
(43) Pub. Date: Jul. 10, 2014

(54) USER CREDENTIAL MANAGEMENT SYSTEM AND METHOD THEREOF

(71) Applicant: Prium Inc., Redmond, WA (US)

(72) Inventor: Umesh J. AMIN, Redmond, WA (US)

(21) Appl. No.: 14/143,320

(22) Filed: Dec. 30, 2013

Related U.S. Application Data
(60) Provisional application No. 61/749,473, filed on Jan. 7, 2013.

(51) Int. Cl. H04L 29/06

(52) U.S. Cl. CPC H04L 63/08; H04L 63/083
USPC 726/6

(57) ABSTRACT

The present invention provides a user credential management system and a method thereof. The system includes a profile creation module configured to facilitate creation of one or more context specific user profiles. Each context specific user profile comprises a set of user credentials. A profile linking module is configured to link the one or more context specific user profiles to a web browser. A profile selection module is configured to facilitate a selection of a context specific user profile from one of web account creation and a first time access to existing web account post creation of the context specific user profiles. The selection is subsequent to display of a web form associated with the web account. The profile selection module is further configured to populate entries corresponding to one or more credential entry fields on the web form based on the selected context specific user profile and auto populate the web form at the subsequent access to the web account.

### CROSS-REFERENCE TO RELATED APPLICATION

This non-provisional patent application claims priority from the U.S. provisional patent application Ser. No. 61/749,473 filed on Jan. 7, 2013, the content of which is incorporated herein by reference.

### FIELD OF THE INVENTION

The present invention relates to web access, and more particularly to managing user credentials related to web access.

### BACKGROUND OF THE INVENTION

The widespread proliferation of the web and the rapid advancement in cloud computing based technology and services related to web access on electronic devices has resulted in an exponential increase in web-based user traffic. Users are increasingly accessing the web for a variety of purposes, such as for personal communication, for networking with social contacts, for banking related services, for online shopping, work related corporate VPN based or cloud based services, and recreational services and the like. The users typically maintain a number of web-based accounts to personalize a web experience. Examples of such web-based accounts include, but are not limited to, email accounts, online shopping accounts, online banking accounts, online brokerage accounts, corporate VPN based and/or cloud services based accounts, online access for credit cards, online loyalty services accounts, online media accounts, online social networking accounts and the like. Each web-based account (referred to hereinafter as web account) requires the user to provide a username, a password, and such other user credentials in order to provide access to the web account. Typically, most of the web accounts are created and managed with a simple username (for example, a first name of the user or a mobile phone number or an email address of the user), much simpler passwords (for example, 123456), and known credentials (for example, mother's maiden name). However, maintaining different usernames and passwords may become difficult and cumbersome for users who maintain and interact with several different web accounts. Accordingly, some users simply adopt a single user name and password for their different web accounts. However, such an approach may be associated with sizable risk as a compromised security of one web account may affect a security of all other user web accounts.

Further, each web account may present a web form to the user during new web account creation or during subsequent access to the web account. The web form is a structured web document with spaces called “form fields” reserved for entering user credential information, such as a user ID, a password, a street address, a onetime use pin, a city name, a telephone number, a security question to retrieve the password in case it is lost and the like. In most cases, subsequent access to the created web account may involve a provision of a web form primarily prompting the user to provide the user ID and the password. However, some web forms such as the web forms used for some e-commerce transactions or online banking or work related VPN accounts, prompt the user to provide entire information multiple times, which is cumbersome for the user. In some conventional mechanisms, the users designate a primary computer as an access device for their web accounts and use browser cookies to avoid the need to repeatedly enter the user credentials. However, due to the risk of fraudulent access and possible financial liabilities, many websites do not allow user credentials to be stored in the browser cookies and require the user to repeatedly enter user credentials or have a multi-stage authentication at each time an account is accessed and has rapid log-off for account inactivities, which is cumbersome for the user.

### SUMMARY OF THE INVENTION

In view of the foregoing disadvantages inherent in the prior-art, the general purpose of the present invention is to provide a user credential management system, a method and a computer-readable medium thereof that is configured to include all advantages of the prior art and to overcome the drawbacks inherent in the prior art offering some added advantages.

In one aspect, the present invention provides a user credential management system. The user credential management system includes a profile creation module, a profile linking module, and a profile selection module. The profile creation module is configured to facilitate creation of one or more context specific user profiles by a user. In an embodiment, a context associated with each context specific user profile corresponds to a type of web account intended to be accessed by the user and has varying level of security. Also, depending on the type of cloud services, the access mechanism and authentication mechanism may vary for public and enterprise types of web accounts. The type of web account is chosen from one among an email account, a banking account, a corporate VPN account, a cloud service based account, a membership account, a loyalty account, a credit card account, an online services account, a social networking account, an online media account, a brokerage account and an e-commerce account. Each context specific user profile from among the one or more context specific user profiles comprises a set of user credentials. The set of user credentials comprises information corresponding to at least one of a username, a user identification, a user email ID, a system generated password, a user generated password, a type of user profile, a user profile name, a web account name, a user home address, a user office address, a user date of birth, a user age, a user gender, a user phone number, a user mobile number, a series of security questions and a series of user selected security answers.

In an embodiment, the profile linking module is configured to link one or more context specific user profiles to a web browser associated with a user device. In an embodiment, the profile linking module is configured to link the one or more context specific user profiles to the web browser using a browser plug-in application programming interface (API). In an embodiment, the profile selection module is configured to facilitate a selection of a context specific user profile from among the one or more context specific user profiles by the user. The selection of the context specific user profile is facilitated subsequent to display of a web form associated with one of a web account and a first time access to existing web account post the creation of context specific user profile. For a subsequent access of the created web account on the web browser, the web form is auto populated through the link between the account, the browser, and the context specific profile. In an embodiment, the selection of the context specific user profile is facilitated by the profile selection module by provisioning a web browser based user interface. The web browser based user interface comprises a drop-down menu comprising options corresponding to the one or more context specific user profiles for user selection and an address entry field for receiving a web address corresponding to the web form from the user. In an embodiment, the selection of the context specific user profile is facilitated by the profile selection module by provisioning a menu option from among a plurality of menu option on the web browser.

In an embodiment, the profile selection module is further configured to populate entries corresponding to one or more credential entry fields on the web form based on the selected context specific user profile. In an embodiment, the profile creation module is further configured to facilitate updating of at least one context specific user profile from among the one or more context specific user profiles. In an embodiment, the profile linking module is further configured to facilitate the linking of at least one updated context specific user profile to the web browser. In an embodiment, the system comprises a profile storage module, which is configured to store the one or more context specific user profiles and facilitate an access to the stored one or more context specific user profiles from multiple user devices associated with the user. In an embodiment, the system is integrated within one of an operating system of the user device and the web browser associated with the user device. In an embodiment, the system is implemented as a mobile application. In yet another embodiment, the system is implemented as a hosted service on a cloud services platform.

In one aspect, the present invention provides a method for managing user credentials with varying level of security. The method comprises facilitating creation of one or more context specific user profiles by a user. Each context specific user profile from among the one or more context specific user profiles comprises a set of user credentials corresponding to with the level of security for the context. The one or more context specific user profiles are linked to a web browser associated with a user device. The method further comprises facilitating a selection of a context specific user profile from among the one or more context specific user profiles from one of web account creation and a first time access to existing web account post creation of the context specific user profile. The selection of the context specific user profile is facilitated subsequent to display of a web form associated with creation or update of a web account. For a subsequent access of the created web account on the web browser, the web form is auto populated through the link between the account, the browser, and the context specific profile. Furthermore, the method comprises populating entries corresponding to one or more credential entry fields on the web form based on the selected context specific user profile.

In one aspect, the present invention provides a computer-readable medium storing a set of instructions that when executed cause a computer to perform a method for managing user credentials. The method comprises facilitating creation of one or more context specific user profiles by a user. Each context specific user profile from among the one or more context specific user profiles comprises a set of user credentials. The one or more context specific user profiles are linked to a web browser associated with a user device. The method further comprises facilitating a selection of a context specific user profile from among the one or more context specific user profiles by the user. The selection of the context specific user profile is facilitated subsequent to display of a web form associated from one of web account creation and a first time access to existing web account post creation of the context specific user profile. At a subsequent access of the created web account on the web browser, the web form is auto populated through the link between the account, the browser, and the context specific profile. Furthermore, the method comprises populating entries corresponding to one or more credential entry fields on the web form based on the selected context specific user profile.

These together with other objects of the invention, along with the various features of novelty that characterize the invention, are pointed out with particularity in the claims annexed hereto and forming a part of this disclosure. For a better understanding of the invention, its operating advantages and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, in which:

FIG. 1 depicts an exemplary overview of an environment in which various embodiments of the present invention may be practised;

FIG. 2 is a block diagram of a user credential management system, according to an exemplary embodiment of the present invention;

FIG. 3 illustrates an exemplary user interface for facilitating creation of a context specific user profile, according to an exemplary embodiment of the present invention;

FIG. 4 illustrates a simplified perspective view of a web browser depicting an exemplary web browser based user interface configured to facilitate a selection of a context specific user profile, according to an exemplary embodiment of the present invention;

FIG. 5 illustrates a simplified perspective view of a web browser configured to facilitate a selection of a context specific user profile, according to an exemplary embodiment of the present invention; and

FIG. 6 illustrates a flow diagram of a method for managing user credentials, according to an exemplary embodiment of the present invention.

Like reference numerals refer to like parts throughout the several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular method and system for managing user credentials as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The use of terms “including,” “comprising,” or “having” and variations thereof herein are meant to encompass the items listed thereafter and equivalents thereof as well as additional items. Further, the terms, “a” and “an” herein do not denote a limitation of quantity, but rather denote the presence of at least one of the referenced item. The term ‘user credentials’ as used herein refers to any user related information, such as a user name, date of birth, gender information, user contact details and the like, which may be used for online account creation and access. The term ‘managing of user credentials’ as used hereinafter refers to the set of actions facilitating creation, storage, and appropriate retrieval of user credentials for web account creation and subsequent web account access.

The present invention provides methods and systems for managing user credentials. Pursuant to an exemplary scenario, users maintain multiple web accounts, such as email accounts, social networking accounts, banking accounts, brokerage accounts, customer service accounts, online shopping accounts and the like. Each web account requires the user to provide a username, a password, and such other user credentials in order to provide access to the web account. Maintaining different usernames and passwords may become difficult and cumbersome for users who maintain and interact with several different web accounts. Further, each web account may present different web forms to the user during new web account creation or during subsequent access to the web account. The use of conventional mechanisms like using browser cookies to avoid the need to repeatedly enter the user credentials may involve the risk of fraudulent access and possible financial liabilities. As such, many websites do not allow user credentials to be stored in the browser cookies and require the user to repeatedly enter user credentials, which is cumbersome for the user. Various embodiments of the present technology, however, provide methods and systems for managing user credentials that are capable of overcoming these and other obstacles and providing additional benefits.

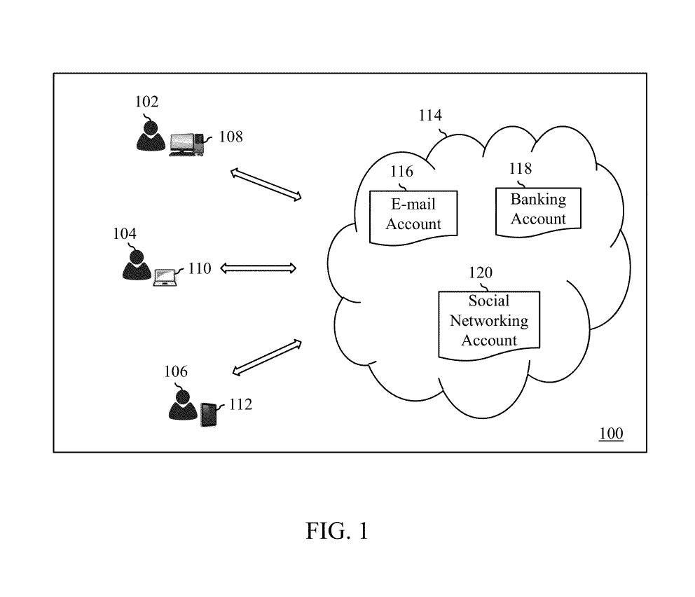

FIG. 1 depicts an overview of an environment 100 in which various embodiments of the present invention may be practised. The environment 100 includes a plurality of users, such as a user 102, a user 104 and a user 106. It is understood that the environment 100 is depicted to include three users for illustration purposes and that the environment 100 may include a plurality of such users. Each user from among the plurality of users is associated with an electronic device for communicating with a network 114 for accessing web accounts such as a web account 116, a web account 118 and a web account 120. For example, the user 102 is associated with an electronic device 108, the user 104 is associated with an electronic device 110 and the user 106 is associated with an electronic device 112. Examples of the electronic devices 108-112 may include, but are not limited to Smartphones, laptops, tablet computers, personal computers and such other electronic devices configured to enable the users 102-106 to communicate with the network 114 for accessing the web accounts such as the web accounts 116-120.

Pursuant to an exemplary scenario, the network 114 represents the web and the electronic devices 108-112 may access the network 114 (i.e. perform web access) over wired networks, wireless networks or any combination thereof. Examples of the wired networks may include the Ethernet, local area network (LAN), fiber-optic cable network and the like. Examples of wireless networks may include cellular networks like GSM/3G/CDMA networks, wireless LAN, Bluetooth or Zigbee networks and the like. An example of a combination of wired and wireless networks may include the Internet.

The term ‘web account’ as used herein refers to a software application capable of being accessed by users over the network 114. Examples of web account may include, but are not limited to, an email account, an online shopping account, a corporate VPN account, a cloud service based account, an online banking account, an online brokerage account, an online loyalty services account, an online media account, an online social networking account and the like. It is understood that the network 114 is depicted to include three web accounts such as an e-mail account, a banking account and a social networking account (for web accounts 116, 118 and 120, respectively) for illustration purposes and that the network 114 may include a plurality of such web accounts. In some exemplary scenarios, the web accounts may be created utilizing browser-supported programming languages, such as JavaScript, and mark-up languages, such as Hypertext Markup Language (HTML), for facilitating web account access through a web browser employed by electronic devices such as the electronic devices 108-112. Examples of the web browser may include any standard browsers used for accessing web accounts, such as a Microsoft™ “Internet Explorer” browser, a Google™ “Chrome” browser, an Apple™ “Safari” browser, a Mozilla™ “Firefox” browser and the like, or even proprietary browsers associated with the electronic devices.

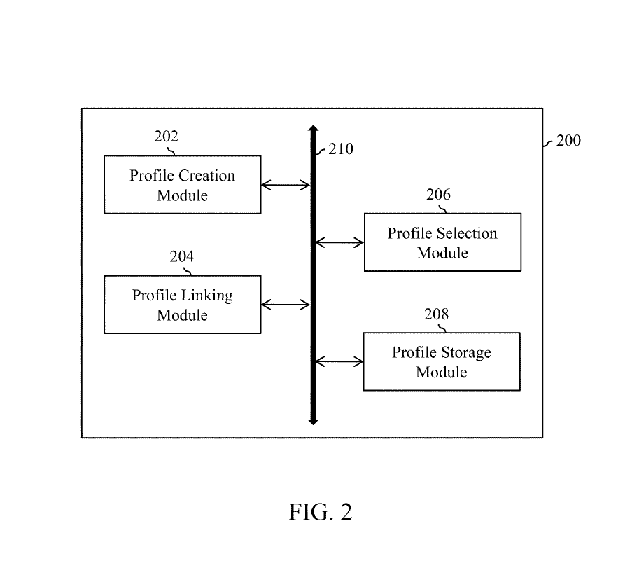

Pursuant to an exemplary scenario, the users such as the users 102-106 may maintain several web accounts, such as the web accounts 116-120 to personalize web access experience. The users may utilize the web browsers on their respective electronic devices for accessing the web accounts. Typically, the web accounts require provision of user credential information such as a username, a password, and such other user credentials from the user in order to provide access to the web accounts. Managing such user credentials may become difficult and cumbersome for the users who maintain several web accounts. A system for managing the user credentials is explained with reference to FIG. 2.

FIG. 2 is a block diagram of a user credential management system 200 according to an embodiment of the present invention. The user credential management system 200 (referred to hereinafter as system 200) is configured to manage the user credentials for accessing web accounts, such as user email accounts, user social networking accounts, corporate VPN accounts, cloud services based accounts, user banking accounts, user membership accounts and the like. In an embodiment, the system 200 may be integrated within an operating system associated with a user device (such as an electronic device from among the electronic devices 108-112 explained with reference to FIG. 1). In an embodiment, the system 200 may be integrated within a web browser associated with the user device. For example, the system 200 may be implemented as a browser plug-in associated with the web browser. In an embodiment, the system 200 may also be implemented as a mobile application within the user device for managing the user credentials. In an embodiment, the system 200 may also be implemented as a cloud services platform hosted service with an application within the user device for managing the user credentials. It is understood that such implementations of the system 200 may entail a software-based implementation of various components of the system 200. However, it is noted that the various components of the system 200 as described hereinafter may be implemented using hardware, software, firmware or any combination thereof in the user device. Examples of the user device may include a personal computer (PC), a tablet PC, a personal digital assistant (PDA), a Smartphone, a mobile communication device, an Internet enabled television (or web TV), an internet enabled gaming console and the like.

In an embodiment, the system 200 includes a profile creation module 202, a profile linking module 204, a profile selection module 206 and a profile storage module 208. The profile creation module 202, the profile linking module 204, the profile selection module 206 and the profile storage module 208 may be communicatively associated with each other using a bus 210. Examples of the bus 210 may include a data bus, a control bus, an address bus, a serial bus, a bi-directional bus and the like. In an embodiment, the various components of the system 200, such as the profile creation module 202, the profile linking module 204, the profile selection module 206 and the profile storage module 208 may be implemented as hardware, software, firmware or any combination thereof. It is noted that in some embodiments, the system 200 may include fewer or more components than those depicted in FIG. 2.

In an embodiment, the profile creation module 202 is configured to facilitate creation of one or more context specific user profiles by a user. A context associated with each context specific user profile corresponds to a type of web account intended to be accessed by the user. Examples of the type of web account may include, but are not limited to, a email account, a banking account, a membership account, a corporate VPN account, a cloud service based account, a brokerage account, a loyalty account, a customer service account, a social networking account, an online media account, an e-commerce account and the like. For example, a user may be assisted in creating a user profile for email related context. The creation of such a user profile may be utilized for creation and subsequent access of multiple user email accounts. Similarly, a user may be assisted in creating a user profile for shopping related context. The creation of such a user profile may be utilized for shopping account creation and subsequent access of multiple online shopping accounts. As such, the term ‘context specific user profiles’ as used herein refers to user profiles that are configured to be specific to a particular context, such as a personal communication context, a networking (with social contacts) context, a corporate VPN or cloud service context, a banking context, a shopping context and a recreational (for example, gaming) context and the like.

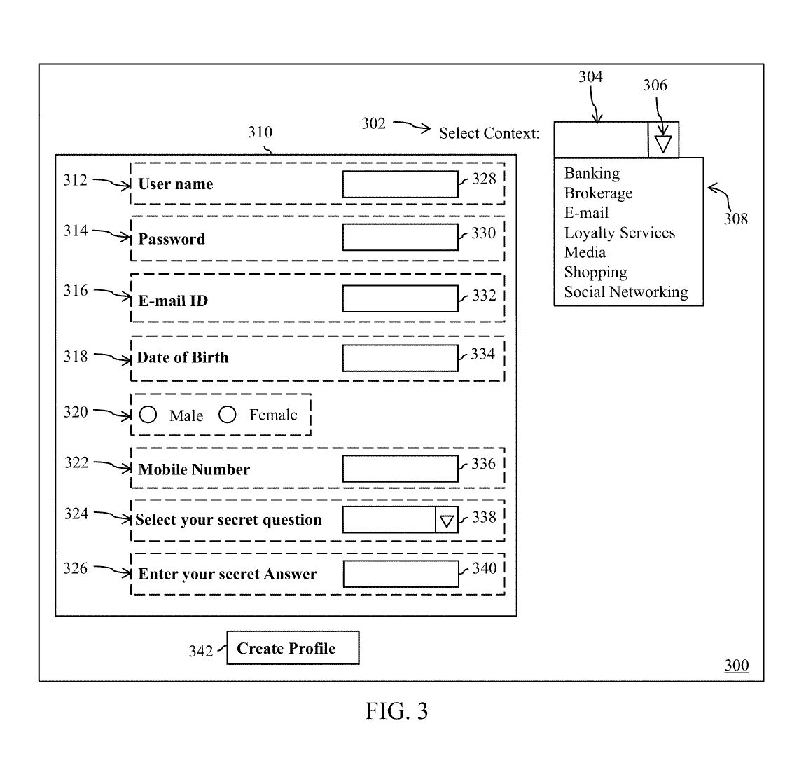

In an embodiment, the user such as the users 102-106 may create several context specific user profiles. The creation of each context specific user profile may involve the provision of set of user credentials. In an embodiment, the set of user credentials may include information corresponding to at least one of a username, a user identification, a user email ID, a system generated password, a user generated password, a type of user profile, a user profile name, a web account name, a user home address, a user office address, a user date of birth, a user age, a user gender, a user phone number, a user mobile number, a user a series of security questions and a series of security answers. The creation of a context specific user profile is further explained with reference to FIG. 3.

FIG. 3 illustrates an exemplary user interface (UI) 300 for facilitating creation of a context specific user profile according to an embodiment of the present invention. As explained with reference to FIG. 2, in some embodiments, the system 200 may be implemented as a mobile application. In such a case, upon accessing the mobile application, the profile creation module 202 of the system 200 may be configured to present a UI, such as UI 300, to the user on a display screen associated with the user device. In some embodiments, the system 200 may be implemented within a web browser. In such cases, the profile creation module 202 of the system 200 may be configured to present the UI 300 upon accessing a menu option in a web browser. Alternatively, a web link may be provisioned to the user and the profile creation module 202 of the system 200 may be configured to present the UI 300 upon accessing the web link through the web browser. It is noted that the creation of context specific user profiles is explained herein with reference to single context user profile creation using UI 300 in FIG. 3. However, it is understood that a plurality of such context specific user profiles may be created by the user using UIs, such as the UI 300, depicting different context and associated credentials with its own level of security.

The UI 300 depicts a ‘select context’ option 302 associated with a text entry box 304. The text entry box 304 includes a drop-down menu access option 306. Upon clicking on the drop-down menu access option 306, a plurality of options 308 for selecting context corresponding to the context user profile intended to be created is presented to the user. The plurality of options 308 for context selection includes options such as Email, Banking, Brokerage, Corporate VPN, Cloud Services, Loyalty Services, Media, Shopping and Social Networking. A user may select an option from among the plurality of options 308 displayed upon clicking on the drop-down menu access option 306. It is understood that the options for selecting context for creation of a context specific user profile are depicted for exemplary purposes and that a plurality of such options may be provided to the user. The user may select an option and create a context specific user profile corresponding to the selected context. For example, the user may select the option ‘Email’ and indicate the choice of creating a context specific user profile for personal communication context. Upon creation of a context specific user profile for the email context, the user may use the created context specific user profile for new email account creation, account update, and subsequent email access for multiple emails account on the web.

The UI 300 is further configured to depict a credential entry section 310. The credential entry section 310 is configured to prompt the user to provision a set of user credentials for creation of the context specific user profile. The credential entry section 310 includes a plurality of “form fields” (hereinafter referred to as fields) associated with text boxes or menu selection options for receiving the user credentials from the user. For example, the credential entry section 310 includes fields 312, 314, 316, 318, 320, 322, 324 and 326 corresponding to user credential entry related to a username, password, email-id, date of birth, gender, mobile number, a series of secret questions and the entry of secret answers. The fields 312, 314, 316, 318, 322 and 326 are associated with text boxes 328, 330, 332, 334, 336 and 340, respectively for receiving corresponding information in a textual format from the user. It is understood that the user may utilize one or more input mechanisms, such as a physical keyboard, a virtual keyboard, a voice input and the like, associated with the user device for providing the input to these fields. The field 320 corresponding to the user gender may provide radio buttons corresponding to the ‘male’ and ‘female’ gender options for user selection. Further, a text box 338 associated with the field 324 corresponding to a series of secret questions may include a drop-down menu option including standardized questions, such as ‘Which city you were born in?’, ‘What is your mother's maiden name?’, ‘model of your first car’, ‘name of a pet’ and the like. A user may select questions from the drop down menu option provided in the text box 338 and type the corresponding answers to the questions in the text box 340. It is noted that the fields depicted in the credential entry section 310 are depicted for exemplary purposes and are not considered to be limiting. Indeed, in various embodiments, the credential entry section 310 may include more or less fields.

In an embodiment, the user may choose a unique username and password for each created context specific user profile. Further, the password may be auto generated to be sufficient length (for example, greater than eight characters) and may include a combination of upper case and lower case characters, numerals and special characters to ensure protection against cyber threats, such as a dictionary based attacks used in hacking of passwords. In an embodiment, the provision of the email ID may serve to direct notifications, subscriptions and other information related to the user profile thereto. In some embodiments, the provision of credentials related to some fields, such as date of birth may be non-mandatory.

The UI 300 further includes a ‘create profile’ clickable button 342, which may be clicked by the user upon completion of a provision of user credentials related to the fields 312-326. In an embodiment, a user profile corresponding to the context chosen in text box 304 and including the set of credentials entered in the credential entry section 310 may be created upon clicking of the ‘create profile’ icon 342. As explained above, the user may choose a different context and provide a different set of user credentials to create multiple such context specific user profiles.

Referring now to FIG. 2, the profile creation module 202 is further configured to facilitate updating of at least one user profile from among the created user profiles. For example, the user may wish to modify/update certain user credentials such as the unique password, the e-mail ID, the mobile number, the secret question, the secret answer and the like. The profile creation module 202 may facilitate such a modification/update by re-provisioning the UI 300 for receiving the new set of user credentials from the user. In some embodiments, the modification or update to the created context specific user profiles may require user authorization (for example, authentication in form of answers to the secret questions or existing password confirmation).

In an embodiment, the profile linking module 204 is configured to link the created user profiles to a web browser associated with a user device. More specifically, upon creation of one or more context specific user profiles as explained with reference to FIG. 3, the created one or more context specific user profiles may be linked to the web browser for managing the user credentials. In an embodiment, the profile linking module 204 is configured to link the one or more context specific user profiles to the web browser using a browser plug-in application programming interface (API). As explained above, in some cases, the user may update at least one context specific user profile from among the one or more context specific user profiles. The profile linking module 204 is configured to subsequently link the updated version of the at least one context specific user profile to the web browser.

In an embodiment, the profile selection module 206 is configured to facilitate a selection of a context specific user profile from among the one or more context specific user profiles by the user. The selection of the context specific user profile is facilitated subsequent to display of a web form associated with from one of web account creation and a first time access to existing web account post creation of the context specific user profile. At a subsequent access of the created web account on the web browser, the user credentials are auto populated in the web form through the link between the account, the browser, and the context specific profile. For example, if a user wishes to create a new web account or accessing existing account for the first time since the creating of the profiles, then the user is typically provided with a web form requesting user credentials for facilitating the creation of the new web account or updating the credential through the profiles. The web form refers to a structured web document with spaces called “credential entry fields” reserved for entering information, such as the information related to user credentials. More specifically, the web form may request user credentials related to user name, password, email ID, address details, gender and the like. On being displayed the web form requesting user credentials, the user may select a context specific user profile from among the one or more context specific user profiles subsequent to the facilitation of such a selection by the profile selection module 206. In an embodiment, the profile selection module 206 is further configured to populate entries corresponding to one or more credential entry fields on the web form based on the selected context specific user profile. The selection of a context specific user profile and the subsequent population of entries corresponding to one or more credential entry fields on the web form based on the selected context specific user profile may be further explained below with the help of an exemplary scenario.

According to the exemplary scenario, a user may wish to create a new web shopping account or access an existing web account post the creation of the profiles. Accordingly, a user may go to a website ‘www.my-shopping.com’ and prompt the website for creation of a new web account or web account update. Upon receiving such a request from the user, the website may provide a web form requesting user credentials for new web account creation or an account update. The profile selection module 206 may facilitate a selection of a context specific user profile from among the plurality of context specific user profiles subsequent to display of the web form associated with one of the creation or update of the web account. As a context associated with the web account relates to shopping, the user may select a context specific user profile related to shopping from among the plurality of context specific user profiles. In an embodiment, upon receiving a selection of a context specific user profile, the profile selection module 206 is configured to populate entries corresponding to one or more credential entry fields on the web form based on the selected context specific user profile.

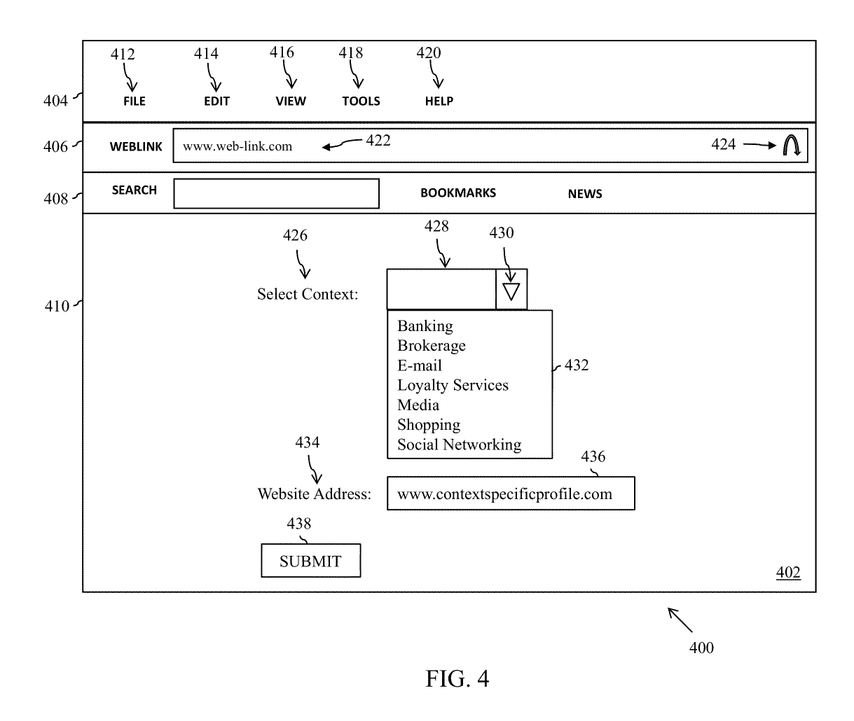

In an embodiment, the selection of the context specific user profile from among the one or more user profiles is facilitated by the profile selection module 206 by provisioning a web browser based user interface. In an embodiment, in the mobile application based implementation of the system 200, the mobile application when invoked may be configured to provision a web browser based user interface to the user. In an embodiment, the web browser based user interface includes (1) a drop-down menu comprising options corresponding to the one or more context specific user profiles for user selection and (2) an address entry field for receiving a web address corresponding to the web form from the user. The user may select a context specific user profile from the drop-down menu and may provide a website address in which the user credentials have to be populated. Once the user has selected the context specific user profile and the provided the website address, the user credentials associated with the context specific user profile are dynamically populated in the web form associated with the website address provided by the user. The facilitation of the selection of the context specific user profile using the web browser based user interface is further explained with reference to FIG. 4.

FIG. 4 illustrates a simplified perspective view of a web browser 400 depicting an exemplary web browser based user interface 402 (hereinafter referred to as ‘user interface 402’) configured to facilitate a selection of a context specific user profile according to an embodiment of the present invention. The web browser 400 is depicted to include a menu bar 404, a web uniform resource locator (URL) section 406, a search bar 408 and a UI display section 410. The menu bar 404 includes menu options such as “File 412”, “Edit 414”, “View 416”, “Tools 418” and “Help 420”. It is noted that the menu options in the menu bar 404 are depicted for exemplary purposes and that the menu bar 404 may include less or more menu options than those displayed in FIG. 4. Further, each menu option of the menu bar 404 may be configured to display upon clicking, a drop down list of secondary menu options. For example, upon clicking on the “File 412” menu option, a drop down list of secondary menu options (not shown in FIG. 4) such as “New Window”, “New Tab”, “Open location”, “Save As” and the like may be displayed. Each of the secondary menu options may be associated with an intended functionality. For example, the “New Window” secondary menu option may facilitate an opening of a new browser window. Similarly, the “Save As” secondary menu option may facilitate saving of the UI on display in one of various formats, such as for example a hypertext markup language (HTML) format or a text format. Each of the menu options such as “Edit 414”, “View 416”, “Tools 418” and “Help 420” may similarly include secondary menu options with associated functionalities.

The web URL section 406 is depicted to include a text box configured to receive user input in form of a web link, such as web link 422 (for example, web link exemplarily depicted as www.web-link.com). The web link 422 may trigger a hypertext transfer protocol (HTTP) request to fetch a desired UI, such as UI 402, corresponding to a web application from over the network, such as network 114 explained with reference to FIG. 1. It is noted that the fetching of the web application may involve standard procedures such as domain name resolutions using a domain name server (DNS) server and the like and are not discussed herein. The web URL section 406 may further include a refresh icon 424 for re-sending the HTTP request for re-fetching the UI corresponding to the web application.

The search bar 408 is depicted to include a text box configured to receive user input in form of a search request. In an embodiment, the search box may be associated with one or more search engines, such as Google search engine, Yahoo search engine and/or Baidu search engine. Upon receiving user input in form of text for searching on the Internet, a UI including results of the search may be displayed to the user. The search bar 408 is further depicted to include tabs for “bookmarks” and “news”. In an example embodiment, a tab for “bookmarks” may be configured to store and/or list user-selected UIs (or web pages) as bookmarks for ease of future access. In an example embodiment, the “news” tab may be configured to facilitate access to UIs corresponding to news related web applications.

The user interface 402 depicts a ‘select context’ option 426 associated with a text entry box 428. The text entry box 428 includes a drop-down menu access option 430. Upon clicking on the drop-down menu access option 430, a plurality of options 432 for selecting context corresponding to a web form of a web account intended to be completed is presented to the user. The plurality of options 432 for context selection includes options such as Email, Banking, Brokerage, Corporate VPN, Cloud services, Loyalty Services, Media, Shopping and Social Networking. A user may select an option from among the plurality of options 432 displayed upon accessing the drop-down menu access option 430. It is understood that the options for selecting context are depicted for exemplary purposes and that a plurality of such options may be provided to the user.

The UI 402 is further configured to depict a website address option 434 including a text box 436 for entering a web URL (for example, www.contextspecificprofile.com) and thereby linking the web form of the web account intended to be accessed to the selected context specific user profile. Upon selecting a context in text box 428 and entering the web URL of the web form in text box 436, the user may click the ‘submit’ button 438. In an embodiment, when the user clicks the ‘submit’ button 438 subsequent to the selection of the context specific user profile and the URL of the web form, the profile selection module 206 of the system 200 is configured to select appropriate user credentials from the selected context specific user profile and populate the corresponding credential entry fields in the web form, thus precluding the need of provisioning the user credential information. If the requested user credentials in the web form are not available in the selected context specific profile, then the user may be prompted to provide the requisite credentials and complete the web form. Thus, the user has to provision only few credentials in some cases and has to remember far less information, thereby improving a user's online experience.

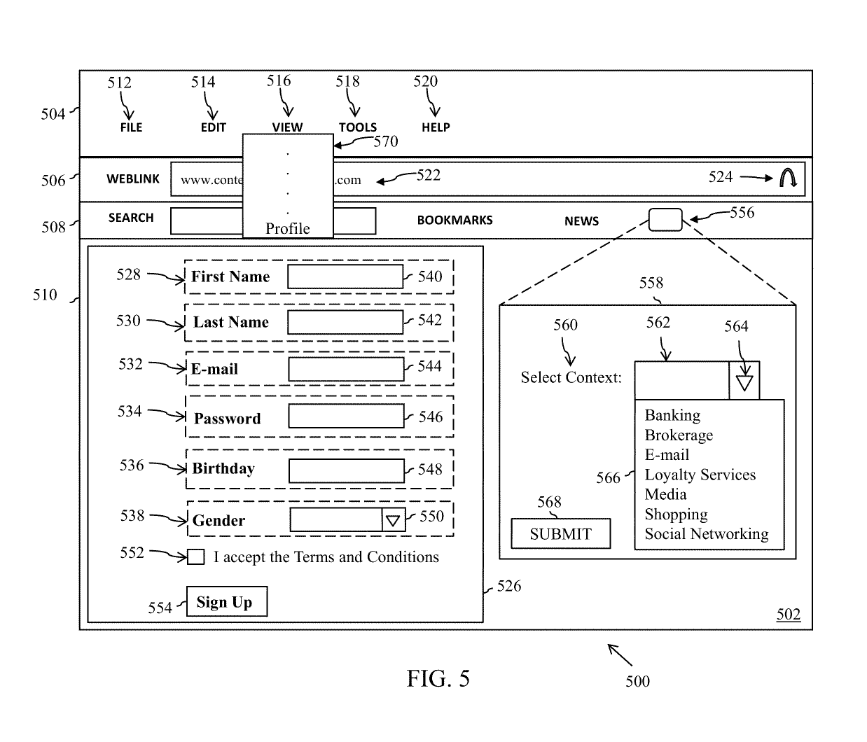

Referring now to FIG. 2, in another embodiment, the selection of the context specific user profile from among the one or more user profiles is facilitated by the profile selection module 206 by provisioning a menu option from among a plurality of menu option associated with a web browser. Accordingly, the user may select his/her desired context specific user profile from the menu option. In an embodiment, subsequent to the selection of the context specific user profile, the user credentials associated with the selected context specific user profile are dynamically populated in a web form associated with a web account. The provisioning of the menu option in the web browser for facilitating a selection of a context specific user profile is further explained with reference to FIG. 5.

FIG. 5 illustrates a simplified perspective view of a web browser 500 configured to facilitate a selection of a context specific user profile according to an embodiment of the present invention. The web browser 500 is depicted to display an exemplary web browser based user interface 502 (hereinafter referred to as ‘user interface 502’). The web browser 500 is further depicted to include a menu bar 504, a web uniform resource locator (URL) section 506, a search bar 508 and a UI display section 510. The menu bar 504 includes menu options such as “File 512”, “Edit 514”, “View 516”, “Tools 518” and “Help 520”. Each menu option of the menu bar 504 may be configured to display upon clicking, a drop down list of secondary menu options. The menu options, such as “File 512”, “Edit 514”, “View 516”, “Tools 518” and “Help 520” are substantially similar to the menu options “File 412”, “Edit 414”, “View 416”, “Tools 418” and “Help 420” explained with reference to FIG. 4 and are not explained herein for sake of brevity.

The web URL section 506 is depicted to include a text box configured to receive user input in form of a web link, such as web link 522 (for example, www.contextspecific.com). The web link 522 may trigger a hypertext transfer protocol (HTTP) request to fetch a desired UI, such as UI 502, corresponding to a web form associated with a web account intended to be created or updated by the user. The web URL section 506 may further include a refresh icon 524 for re-sending the HTTP request for re-fetching the UI corresponding to the web application. The search bar 508 is depicted to include a text box configured to receive user input in form of a search request. The search bar 508 is further depicted to include tabs for “bookmarks” and “news”. The tabs “bookmarks” and “news” function in a similar manner as the tabs “bookmarks” and “news” explained with reference to the search bar 408 in FIG. 4 and are not explained herein for sake of brevity.

The UI display section 510 is depicted to display the UI 502 corresponding to the web link 522. The UI 502 depicts a web form 526 associated with a new web account creation or update. The web form 526 includes a plurality of fields requesting user credentials such as “First Name” 528, “Last name” 530, “E-mail” 532, “Password” 534, “Birthday” 536 and “Gender” 538. It is understood that the web form 526 is depicted to include six fields for illustration purposes and that the web form 526 may include fewer or more number of fields. Each field is associated with a text entry box for facilitating the user to provide information regarding the user credentials. In an embodiment, text boxes 540, 542, 544, 546 and 548 are associated with the fields “First Name” 528, “Last Name” 530, “E-mail” 532, “Password” 534, and “Birthday” 536. A drop-down menu 550 is associated with the field “Gender” 538 facilitating selection of “Male” or “Female” options. In an embodiment, the web form 526 is further depicted to include a check box 552 for receiving user acceptance to the terms and conditions for associated with web account creation or update. The web form 526 is further depicted to include a clickable button 554 labelled “Sign Up”, which is configured to confirm the sending of the user credentials for facilitating the creation of the web account. It is noted that a web form substantially similar to the web form 526 may be provided to the user upon subsequent access to the web account upon web account creation.

As explained with reference to FIG. 2, the system 200 may be implemented as a mobile application or may be integrated within a web browser. In such scenarios, the profile selection module 206 of the system 200 is configured to provision a menu option from among a plurality of menu option associated with a web browser (such as the web browser 500) to facilitate the selection of a context specific user profile. Accordingly, the search bar 508 is depicted to include a menu option 556 for facilitating the selection of context specific user profile.

In an embodiment, when the user invokes the menu option 556 for example, by clicking on the menu option 556, a pop-up menu 558 may be displayed to the user as displayed in the inset view. The pop-up menu 558 depicts a ‘select context’ option 560 associated with a text entry box 562. The text entry box 562 includes a drop-down menu access option 564. Upon clicking on the drop-down menu access option 564, a plurality of options 566 for selecting context specific profile corresponding to the web form 526 is presented to the user. The plurality of options 566 for context specific profile selection includes options such as Email, Banking, Brokerage, Corporate VPN, Cloud Services, Loyalty Services, Media, Shopping and Social Networking. For example, if the web form corresponds to banking account creation, then the user may select context specific user profile corresponding to banking context from the plurality of options 566 displayed upon clicking on the drop-down menu access option 564. The pop-up menu 558 is further depicted to include a clickable button 568 labelled “Submit”, which is configured to confirm a selection of the context specific user profile by the user.

In another embodiment, upon integration of the system 200 as a browser plug-in API, the profile selection module 206 may be configured to facilitate the selection of the context specific profile by provisioning a menu option in the main menu section of the web browser 500. For example, the user may access a menu option such as “View” 516 for viewing a drop down list 570 of secondary menu options. In an embodiment, the secondary menu options may include a profile option which when invoked by the user displays a pop-up menu such as a pop-up menu 558 for selecting the context specific user profile. Upon clicking the submit button 568 in the pop-up menu 558, the profile selection module 206 is configured to dynamically populate the set of user credentials associated with the context specific user profile in appropriate fields in the web form 526. The user may then click on the check box 552 and thereafter click on the ‘sign up’ button 554 for initiating the web account creation or update. If the user is presented a web form, similar to the web form 526 during subsequent access to the web account, then the user may similar access the context specific user profile from the menu options and dynamically populate the fields provided in the web form.

Referring now to FIG. 2, the profile storage module 208 of the system 200 is configured to store the one or more context specific user profiles and facilitate an access to the stored one or more user profiles from multiple user devices associated with the user. In an embodiment, the user profiles that are created as explained with reference to FIG. 3 may be stored in the profile storage module 208 for subsequent access of the user profile in case of a data loss. In some embodiments, the profile storage module 208 may be configured using one or more volatile memories, one or more non-volatile memories or a combination of volatile and non-volatile memories. Examples of a volatile memory may include, but are not limited to, random access memory, dynamic random access memory, static random access memory, and the like. Examples of a non-volatile memory may include, but are not limited to hard disk, magnetic tape, optical disk, programmable read only memory, erasable programmable read only memory, electrically erasable programmable read only memory, flash memory, and the like.

In some embodiments, the profile storage module 208 may be communicably associated with a remote server (or cloud based server). Further, the context specific user profiles that are stored in the profile storage module 208 may be transferred to the multiple user devices such as Smartphones, laptops, tablet computers, personal computers and such other electronic devices for facilitating the access to the web accounts based on the set of user credentials associated with the stored user profiles. In an embodiment, the profile storage module 208 may be configured to facilitate setting up of a frequency of performing a back-up of all context specific user profiles created by the user in a network based service so that the corresponding information may be accessed from multiple devices associated with the user.

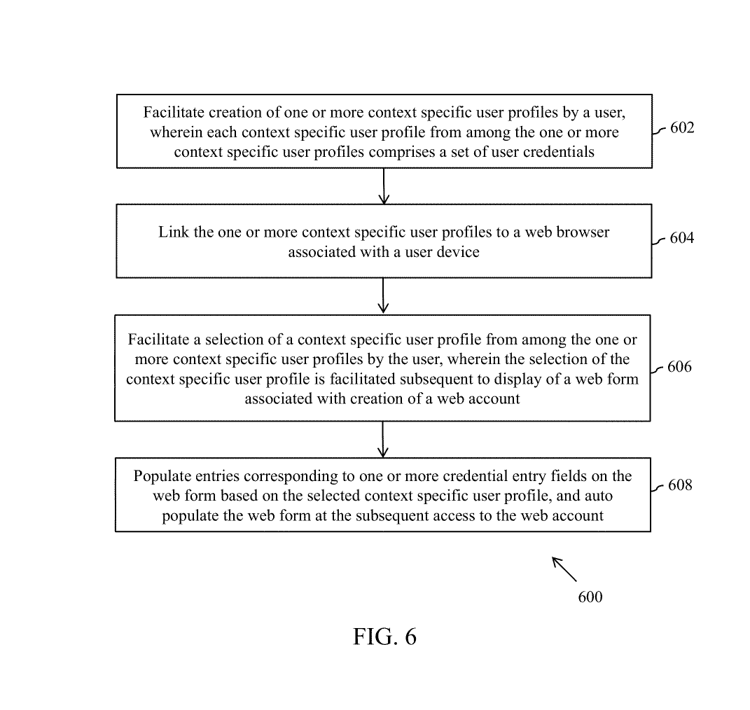

As explained above, in some embodiments, the system 200 may be integrated within the operating system associated with the electronic devices for managing the user credentials. Examples of the electronic devices may include, but are not limited to, smart phones, laptops, tablet computers, personal computers, Internet enabled WebTV's, Internet enabled gaming consoles and such other electronic devices. Examples of the operating system may include, but are not limited to, a Google™ Android, Microsoft™ Windows, an Apple™ MacOS and iOS and the like. In some embodiments, the system 200 may be integrated within the web browser. Examples of the web browser may include, but not limited to, a Microsoft™ “Internet Explorer” browser, a Google™ “Chrome” browser, an Apple™ “Safari” browser, a Mozilla™ “Firefox” browser and the like. In some embodiments, the system 200 may be incorporated within an Internet appliance's access management and security functionally. In an embodiment, the system 200 may also be implemented as a cloud service platform hosted service such as Microsoft's Windows Azure or Amazon's Amazone Web Services, or IBM's SmartCloud with an application within the user device for managing the user credentials. A method for managing user credentials is explained with reference to FIG. 6.

FIG. 6 illustrates a flow diagram of a method 600 for managing user credentials according to an embodiment of the present invention. The method 600 depicted in flow diagram may be executed by, for example, the system 200 of FIG. 2. Operations of the flowchart, and combinations of operation in the flowchart, may be implemented by various means, such as hardware, firmware, processor, circuitry and/or other device associated with execution of software including one or more computer program instructions. The operations of the method 600 are described with help of the system 200. However, the operations of the method 600 can be described and/or practiced by using any other system. The method 600 starts at operation 602.

At operation 602, creation of one or more context specific user profiles by a user is facilitated (for example, by the profile creation module 202 of the system 200). Each user profile from among the one or more user profiles comprises a set of user credentials. The set of user credentials comprises information corresponding at least one of a username, a user identification, a user email ID, a system generated password, a user generated password, a type of user profile, a user profile name, a web account name, a user home address, a user office address, a user date of birth, a user age, a user gender, a user phone number, a user mobile number, a set of security questions and user selected security answers. The creation of user profiles may be facilitated by provisioning a UI, such as the UI 300, as explained with reference to FIG. 3.

At operation 604, the one or more context specific user profiles are linked to a web browser associated with a user device (for example, by the profile linking module 204 of the system 200). In an embodiment, the one or more context specific user profiles are linked to the web browser using a browser plug-in application programming interface (API). The linking of the user profiles to the web browser may be performed as explained with reference to FIG. 2. In an embodiment, the set of user credentials associated with at least one context specific user profile may be updated and then linked to the web browser.

At operation 606, selection of a user profile from among the one or more context specific user profiles by the user is facilitated (for example, by the profile selection module 206 of the system 200). The selection of the context specific user profile is facilitated subsequent to display of a web form associated with one of a creation or update of a web account and a subsequent access of the created web account on the web browser. In an embodiment, the selection of the context specific user profile from among the one or more context specific user profiles is facilitated by provisioning a web browser based user interface, such as the UI 402. In an embodiment, the selection of the context specific user profile is facilitated by provisioning a menu option from among a plurality of menu option associated with the web browser, such as the web browser 500. At operation 608, entries corresponding to one or more credential entry fields on a web form are populated based on the selected user profile (for example by the profile selection module 206). The selection of the context specific user profile and population of the user credentials based on the selected context specific user profile may be performed as explained with reference to FIGS. 4 and 5 and are not explained herein.

Without in any way limiting the scope, interpretation, or application of the claims appearing below, advantages of one or more of the exemplary embodiments disclosed herein include managing user credentials while precluding the user to manually provide the user credentials every time during any one of the initial web account creation, subsequent access, and account credential updates of the created web account. The methods and systems of the present invention enable automatic population of the user credentials on a web form based on the selected context specific user profile for managing the user credentials.

Further, the methods and systems of the present invention permits the users to create the user profiles once and the use the created user profile multiple times for accessing and managing the user credentials. Further, if a newly created web account requires a multi-tiered authentication, which requires one or more user credentials such as a username, a password and other user credentials, the system automatically populates a web form with the required user credentials for accessing the web-based user account. Further, the present invention eliminates the need for remembering the user credentials for the each web account. Further, the present invention provides an opportunity to create stronger user authentication credentials based on the user's perceived varying levels of needs for the security and provides a seamless and effortless access to web-based user accounts with more secure access.

Embodiments of the present invention include one or more computer programs stored or otherwise embodied on a computer-readable medium, wherein the computer programs are configured to cause a processor to perform one or more steps. A computer-readable medium storing, embodying, or encoded with a computer program, or similar language, may be embodied as a tangible data storage device storing one or more software programs that are configured to cause a processor to perform one or more steps. Such steps may be, for example, any of the steps/operations described herein. Additionally, a tangible data storage device may be embodied as one or more volatile memory devices, one or more non-volatile memory devices, and/or a combination of one or more volatile memory devices and non-volatile memory devices.

Also, techniques, devices, subsystems and methods described and illustrated in the various embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled to each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

What is claimed is:

1. A user credential management system comprising:
a profile creation module configured to facilitate creation of one or more context specific user profiles, wherein each context specific user profile from among the one or more context specific user profiles comprises a set of user credentials;
a profile linking module configured to link the one or more context specific user profiles to a web browser associated with a user device; and
a profile selection module configured to
facilitate a selection of a context specific user profile from among the one or more context specific user profiles from one of web account creation and a first time access to existing web account post creation of the context specific user profiles, wherein the selection of the context specific user profile is facilitated subsequent to display of a web form associated with the web account; and
populate entries corresponding to one or more credential entry fields on the web form based on the selected context specific user profile and auto populate the web form at the subsequent access to the web accounts.

2. The system as claimed in claim 1, wherein a context associated with the each context specific user profile corresponds to a type of web account of varying security level intended to be accessed by the user, and, wherein the type of web account is chosen from one among an email account, a banking account, a membership account, a loyalty account, a corporate VPN account, a cloud service based account, a credit card account, a brokerage account, an online services account, a social networking account, an online media account, and an e-commerce account.

3. The system as claimed in claim 1, wherein the set of user credentials comprises information corresponding to at least one of a username, a user identification, a user email ID, a system generated password, a user generated password, a type of user profile, a user profile name, a web account name, a user home address, a user office address, a user date of birth, a user age, a user gender, a user phone number, a user mobile number, a series of security questions and a series of security answers.

4. The system as claimed in claim 1, wherein the profile linking module is configured to link the one or more context specific user profiles to the web browser using a browser plug-in application programming interface (API).

5. The system as claimed in claim 1, wherein the selection of the context specific user profile is facilitated by the profile selection module by provisioning a web browser based user interface comprising:
a drop-down menu comprising options corresponding to the one or more context specific user profiles for user selection; and
an address entry field for receiving a web address corresponding to the web form from the user.

6. The system as claimed in claim 1, wherein the selection of the context specific user profile is facilitated by the profile selection module by provisioning a menu option from among a plurality of menu options on the web browser.

7. The system as claimed in claim 1, wherein the profile creation module is further configured to facilitate updating of at least one context specific user profile from among the one or more context specific user profiles.

8. The system as claimed in claim 7, wherein the profile linking module is further configured to facilitate the linking of at least one updated context specific user profile to the web browser.

9. The system as claimed in claim 1, further comprising a profile storage module configured to store the one or more context specific user profiles and facilitate an access to the stored one or more context specific user profiles from multiple user devices associated with the user.

10. The system as claimed in claim 1, wherein the system is integrated within one of an operating system of the user device and the web browser associated with the user device.

11. The system as claimed in claim 1, wherein the system is implemented as a mobile application.

12. A method for managing user credentials, the method comprising:
facilitating creation of one or more context specific user profiles by a user, wherein each context specific user profile from among the one or more context specific user profiles comprises a set of user credentials;
linking the one or more context specific user profiles to a web browser associated with a user device;
facilitating a selection of a context specific user profile from among the one or more context specific user profiles from one of web account creation and a first time access to existing web account post creation of the context specific user profile, wherein the selection of the context specific user profile is facilitated subsequent to display of a web form associated with the web account and
populating entries corresponding to one or more credential entry fields on the web form based on the selected context specific user profile; and auto populate the web form at the subsequent access to the web accounts.

13. The method as claimed in claim 12, wherein a context associated with the each context specific user profile corresponds to a type of web account of varying security level intended to be accessed by the user, and, wherein the type of web account is chosen from one among an email account, a banking account, a membership account, a loyalty account, a corporate VPN account, a cloud service based account, a credit card account, a brokerage account, an online services account, a social networking account, an online media account, and an e-commerce account.

14. The method as claimed in claim 12, wherein the selection of the context specific user profile is facilitated by provisioning a web browser based user interface comprising:
a drop-down menu comprising options corresponding to the one or more context specific user profiles for user selection; and
an address entry field for receiving a web address corresponding to the web form from the user.

15. The method as claimed in claim 12, further comprising:
facilitating update of at least one context specific user profile from among the one or more context specific user profiles; and
linking at least one updated context specific user profile to the web browser.

16. The method as claimed in claim 12, further comprising storing the one or more context specific user profiles and facilitating an access to the stored one or more context specific user profiles from multiple user devices associated with the user.

17. A computer-readable medium storing a set of instructions that when executed cause a computing device to perform a method for managing user credentials, the method comprising:
facilitating creation of one or more context specific user profiles, wherein each context specific user profile from among the one or more context specific user profiles comprises a set of user credentials;
linking the one or more context specific user profiles to a web browser associated with a user device;
facilitating a selection of a context specific user profile from among the one or more context specific user profiles from one of web account creation and a first time access to existing web account post creation of the context specific user profile, wherein the selection of the context specific user profile is facilitated subsequent to display of a web form associated with the web account and
populating entries corresponding to one or more credential entry fields on the web form based on the selected context specific user profile and auto populate web form at the subsequent access to the web accounts.

18. The computer-readable medium as claimed in claim 17, wherein a context associated with the each context specific user profile corresponds to a type of web account of varying security level intended to be accessed, and, wherein the type of web account is chosen from one among an email account, a banking account, a membership account, a loyalty account, a corporate VPN account, a cloud service based account, a credit card account, a brokerage account, an online services account, a social networking account, an online media account, and an e-commerce account.

19. The computer-readable medium as claimed in claim 17, wherein the selection of the context specific user profile is facilitated by provisioning a web browser based user interface comprising:
a drop-down menu comprising options corresponding to the one or more context specific user profiles for user selection; and
an address entry field for receiving a web address corresponding to the web form from the user.

20. The computer-readable medium as claimed in claim 17, wherein the method further comprises:
facilitating update of at least one context specific user profile from among the one or more context specific user profiles; and
linking at least one updated context specific user profile to the web browser.
